(19) United States
(12) Patent Application Publication
(10) Pub. No.: US 2013/0052475 A1
(43) Pub. Date: Feb. 28, 2013

(54) METHOD OF FABRICATING POROUS FILM STRUCTURE USING DRY PROCESSES AND POROUS FILM STRUCTURES FABRICATED BY THE SAME

(71) Applicants: Sang Hoon KIM, Gyeonggi-Do (KR); Ji Young BYUN, Seoul (KR); Heon Phil HA, Seoul (KR); Chae Sun LIM, Incheon (KR); Do Hyung KIM, Seoul (KR); Jeong Beom CHOI, Gyeonggi-Do (KR)

(72) Inventors: Sang Hoon KIM, Gyeonggi-Do (KR); Ji Young BYUN, Seoul (KR); Heon Phil HA, Seoul (KR); Chae Sun LIM, Incheon (KR); Do Hyung KIM, Seoul (KR); Jeong Beom CHOI, Gyeonggi-Do (KR)

(73) Assignee: KOREA INSTITUTE OF SCIENCE AND TECHNOLOGY, Seoul (KR)

(21) Appl. No.: 13/589,416

(22) Filed: Aug. 20, 2012

(30) Foreign Application Priority Data
Aug. 23, 2011 (KR) 10-2011-0084027
Oct. 31, 2011 (KR) 10-2011-0112253

(51) Int. Cl. C22C 3/00; B32B 15/00

(52) U.S. Cl. 428/606; 216/56

(57) ABSTRACT

Provided are a method of fabricating a porous thin film structure, by forming a thin film from at least two elements, followed by selectively removing the certain element using a dry etching process, and a porous thin film structure fabricated by the same. Because all processes of the method of fabricating a porous thin film structure are dry processes, process control is simply accomplished, environmental impact is low, and mass production is possible, in contrast to when using a typical wet process such as electrodeposition or dealloying. Also, since a level of porosity is easily controlled and maintained uniform, a mesoporous thin film structure showing a reproducible level of sensitivity when used as a sensor can be fabricated.

### CROSS-REFERENCE TO RELATED APPLICATION

This application claims priorities to and the benefit of Korean Patent Application Nos. 2011-0084027 filed on Aug. 23, 2011 and 2011-0112253 filed on Oct. 31, 2011 the disclosure of which is incorporated herein by reference in its entirety.

### BACKGROUND

1. Field of the Invention

The present invention relates to a method of fabricating a porous thin film structure, by depositing at least two elements having different reactivity with a certain reactive gas at the same time to form a thin film, followed by selectively removing the element having the higher reactivity with the certain reactive gas from the thin film using a dry etching process, and a porous thin film structure fabricated by the same.

2. Discussion of Related Art

Mesoporosity means porosity wherein a pore size is in a range of 2 to 50 nm. A mesoporous thin film structure is the subject of active research to determine its applicability in various biosensors, pH sensors, electrodes for fuel cells, energy storage devices, etc. in a laboratory scale. Also, some active research is aiming at commercializing the mesoporous thin film structure.

In general, electrochemical electrodeposition or dealloying has been used as a method of fabricating a mesoporous thin film structure. However, the electrodeposition has problems in that a solution should be maintained at a constant concentration during a process, great effort is required for process control, and environmental impact is high due to use of a large amount of harmful acid and base during the process. Due to these problems, it is desirable to fabricate a mesoporous thin film structure using electrodeposition for testing in a laboratory, but it is very difficult to actually commercialize and mass produce the mesoporous thin film structure. To solve these problems, a dealloying method that includes fabricating a thin film using a dry method such as sputter deposition, selectively dissolving a certain element (i.e., Si, etc.) having high reactivity in an electrolyte such as HF, and finally fabricating a mesoporous thin film structure using the resulting solution has been proposed. However, since the dealloying method should be performed as a wet process, it also has a problem in that a process of providing each sample with an electrochemical device is cumbersome.

Meanwhile, a dry etching process in which a certain structure is formed on a substrate such as an Si wafer by removing a certain element of the substrate by reaction with a certain gas having high reactivity is widely used in a semiconductor process. In general, a metal thin film is coated on a substrate, and a photoresist is coated on the metal thin film and exposed to light using a pattern having a desired structure. Thereafter, when the substrate is exposed to a certain gas having high reactivity with the sample, an exposed region is removed by reaction with the gas, and the metal thin film beneath the removed photoresist is also removed. However, an unexposed region of the metal thin film beneath the photoresist remains unremoved. When the remaining photoresist is finally removed, the metal thin film on the substrate has the same pattern as that used in light exposure.

### SUMMARY OF THE INVENTION

The present invention is directed to a method of fabricating a mesoporous thin film structure capable of solving the problems of a wet process and facilitating process control by performing all processes using only dry processes, thereby improving upon a typical process in which a sample undergoes a wet process in fabrication of a thin film structure having porosity (including mesoporosity).

As the method of fabricating a mesoporous thin film structure, the present invention proposes a method in which all processes are dry processes.

More particularly, according to an aspect of the present invention, there is provided a method of fabricating a porous thin film structure that includes forming an alloy thin film by depositing at least two elements having different reactivity with a certain reactive gas at the same time, and fabricating a porous thin film by selectively removing the element having the higher reactivity with the certain reactive gas from the alloy thin film.

Preferably, in the forming of the alloy thin film, the alloy thin film is formed by one of methods such as sputter-deposition, PVD (physical vapor deposition), CVD (chemical vapor deposition), CVD based deposition, and plasma deposition of the at least two elements.

Preferably, the forming of the alloy thin film is performed using a method of depositing at least two elements at the same time. Here, the at least two elements are selected from the group consisting of Pt, Pd, Ru, Rh, Ag, Au, Cr, Mn, Fe, Co, Ni, Cu, Si, As, Ge, Os, Re, Te, Ir, Al, B, C, O, N, P, Ti, V, Zr, Nb, Mo, Hf, Ta and W.

Preferably, in the fabricating of the porous thin film, the element is selectively removed using one of methods such as reactive ion etching (RIE), inductively coupled plasma (ICP), electron cyclotron resonance (ECR) and helicon discharge.

Preferably, in the fabricating of the porous thin film, the element is selectively removed using at least one reactive gas selected from the group consisting of non-plasma-type reactive gases containing fluorine (F) such as XeF₂, BrF₃ and ClF₃, a group of non-plasma-type reactive gases containing chlorine (Cl) such as CCl₄ and Cl₂, and a group of non-plasma-type reactive gases containing bromine (Br) such as Br₂.

Preferably, in the fabricating of the porous thin film, the element to be selectively removed is at least one selected from the group consisting of Si, As, Ge, Os, Re, Te, Ir, Al, B, C, O, N, P, Cu, Cr, Ti, V, Zr, Nb, Mo, Hf, Ta and W.

Preferably, the porous thin film structure includes pores having a size of 0.1 to 500 nm.

Preferably, the porous thin film structure has a thickness of 0.1 to 1,000 nm.

Preferably, the porous thin film structure has a roughness factor of 1 to 1,000.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1A and FIG. 1B are scanning electron microscope images of a mesoporous Pt thin film fabricated using a non-plasma-type XeF₂ etcher in Example 1, wherein FIG. 1A is a top view and FIG. 1B is a cross-sectional view;

FIG. 2 is a scanning electron microscope image of a mesoporous Pt thin film fabricated using a plasma-type RIE method in Example 2;

FIG. 3 is a scanning electron microscope image of a mesoporous Au thin film fabricated using a non-plasma-type XeF₂ etcher in Example 3;

FIG. 4 is a scanning electron microscope image of a mesoporous Pt thin film fabricated using an ICP etch method in Example 4;

FIG. 5 is a scanning electron microscope image of a mesoporous Ag thin film fabricated using a non-plasma-type XeF₂ etcher in Example 5; and

FIG. 6 is a scanning electron microscope image of a mesoporous Pd thin film fabricated using a non-plasma-type XeF₂ etcher in Example 6.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

To fabricate a porous thin film according to the present invention as described herein, first, a method of forming a thin film by one of methods such as sputter-deposition, PVD (physical vapor deposition), CVD (chemical vapor deposition), CVD based deposition, and plasma deposition of at least two elements at the same time is used.

In the case of a sputter deposition method, processes are simple, and the risk of producing environmental pollutants is low. In a thin film fabricated by adjusting a deposition rate of elements to be deposited, a thickness and compositions of the thin film may be readily adjusted. In addition, it is possible to readily adjust a level of porosity in the fabricated thin film and maintain a uniform level of porosity.

According to the present invention, compositions of a thin film to be fabricated may be adjusted by adjusting a composition ratio of at least two elements used in the forming of the alloy thin film, a position of a target element and a distance between the target element and a sample on which a thin film is formed. According to the present invention, the porosity may be adjusted according to a volume ratio of elements to be etched, since a porous structure is formed using a dry etching process as will be described later.

Preferably, the thin film is fabricated so that the thin film can have a thickness of 0.1 to 1,000 nm. When the thickness of the thin film is less than 0.1 nm, the thin film is not a thin film anymore and has a separate atom size. Therefore, it is impossible to fabricate the thin film using a sputtering method. On the other hand, when the thickness of the thin film exceeds 1,000 nm, materials may be wasted, fabrication costs may increase, and detection performance may deteriorate due to reaction out of the range required for detection.

Next, a dry etching process using a plasma- or non-plasma-type reactive gas is used in the present invention to selectively remove a certain element from the fabricated alloy thin film. More particularly, a method using a plasma-type reactive gas includes methods such as RIE, deep trench RIE, ICP, ECR or helicon discharge. Also, the etching may be performed using at least one reactive gas selected from the group consisting of non-plasma-type reactive gases containing F such as XeF₂, BrF₃ and ClF₃, a group of non-plasma-type reactive gases containing Cl such as CCl₄ and Cl₂, and a group of non-plasma-type reactive gases containing bromine (Br) such as Br₂, as the non-plasma-type reactive gas. The etching may be generally performed using the equipment and conditions used in a typical dry etching method, which are substantially identical to the equipment and conditions used in the etching method.

The expression “difference of reactivity with a certain reactive gas” means a difference in vapor pressure when an element binds with a certain reactive gas. That is, when an element binds with a certain reactive gas, the element having a higher vapor pressure is removed more quickly than the element having a lower vapor pressure. As a result, as the difference in vapor pressure of the two elements increases, the etching may be effectively performed due to high selectivity.

According to the present invention, an etching level may be adjusted in the etching method using a plasma-type reactive gas by adjusting an RF power used to form plasma, an intensity of a magnetic field, a density of plasma formed by adjusting a reactive gas pressure in a chamber, and ion bombardment energy. Since the use of plasma accelerates the flow of plasma toward a sample, the etching is generally performed with anisotropic plasma. Also, isotropic etching may be performed by adjusting the conditions.

Meanwhile, since a reactive gas is not ionized in an etching method using the non-plasma-type reactive gas, the flow of the reactive gas toward a substrate is not accelerated. So, isotropic etching generally takes place. An etching rate is adjusted according to a pressure and a reaction time of the reactive gas. In general, the etching rate is in a range of 1 to 3 μm/min.

In a thin film structure fabricated by the method, pores are preferably adjusted so that the pores can have a size of 2 to 50 nm. This is because when the pores have this size, the structure is defined as “mesoporous,” and is especially reported to show useful properties. However, the porosity in the present invention is not limited to the mesoporosity.

In the mesoporous thin film structure according to the present invention, the mesoporous thin film preferably has a roughness factor of approximately 1 to 1,000. The term “roughness factor” refers to a value defined as a ratio of an actual surface area of a thin film per geometric unit area. For example, in case that the actual surface area is 40 cm² as measured for an area having a length 1 cm and a width of 1 cm, the roughness factor is 40. A roughness factor of a metal nanostructure is generally calculated from adsorption/desorption of hydrogen atoms in a nanostructure using cyclic voltammetry (CV) in an electrochemical device.

In the porous thin film structure fabricated according to the present invention, the size and roughness factor of pores have above mentioned ranges. Then, when the pores are too small, it is difficult for molecules of a material to be detected to enter the pores. On the other hand, when the pores are too large, a porous structure itself is very weak, and an actual surface area of a thin film may be reduced.

Hereinafter, the present invention will be descried in further detail referring to the following Examples. However, it should be understood that that the description proposed herein is merely a preferable example for the purpose of illustration only, and is not intended to limit the scope of the invention.

### EXAMPLE 1

To form a thin film structure including at least two elements, Pt and Si were sputter-deposited at the same time. First, a Ti adhesive layer was deposited on a surface of an n-doped Si (100) wafer to 3 nm, and a Pt underlayer was then deposited to 30 nm. Next, a Pt—Si cosputter thin film was deposited to 150 nm. Positions of a Pt target and an Si target and their distances from a sample were adjusted so that a content of Si in the Pt—Si thin film could reach 80% by volume.

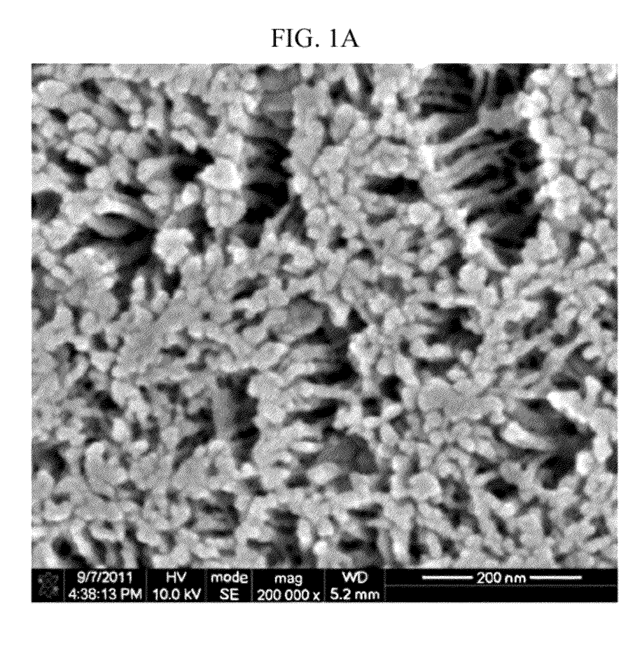

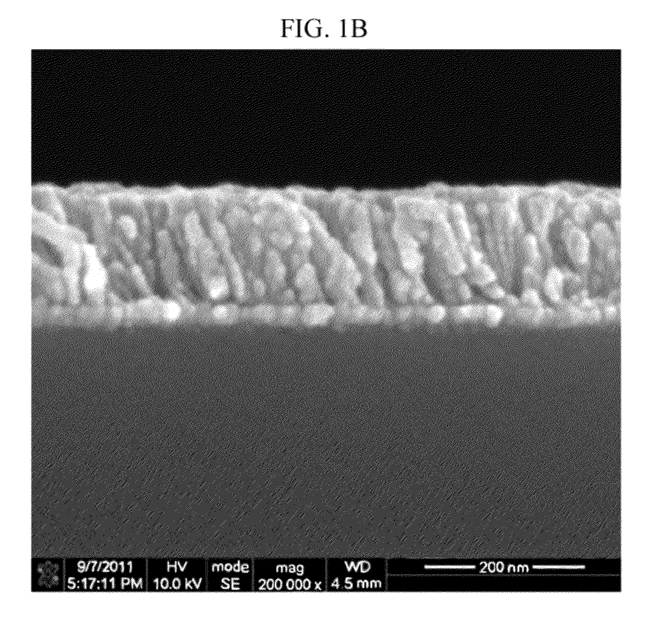

To remove elemental Si from the thin film, the thin film was etched for 30 seconds at a XeF₂ pressure of 1 Ton using a non-plasma-type XeF₂ dry etcher, thereby removing Si in the thin film. FIG. 1A and FIG. 1B are scanning electron microscope images of a Pt porous thin film obtained by this method. FIG. 1A shows the fabricated porous thin film from the top (top view), and FIG. 1B shows the fabricated porous thin film in cross-section from the side (cross-sectional view). With the reference to FIG. 1A, it can be seen that the places from which Si was removed by etching are empty, and the remaining Pt elements have a porous structure composed of pillars having a size of several tens of nanometers. Also, the pores in this structure have a size of several tens of nanometers, which corresponds to a mesoporous nanostructure. With the reference to FIG. 1B, it can be seen that the Pt pillars and the pore structure extend to the bottom of the Pt underlayer. That is, it can be seen that the mesoporous structure of the thin film according to the present invention not only extends to a surface of the thin film but also passes through the thin film.

When an electrochemical device in which the fabricated porous thin film, a Pt wire and AgCl are coupled respectively to a working electrode, a counter electrode and a reference electrode was designed and measured in a 0.5M sulfuric acid solution using CV (cyclic voltammetry), the Pt thin film had a roughness factor of 40.9. Five mesoporous Pt thin films were fabricated repeatedly, and their roughness factors were measured in the same manner as described above. All the mesoporous Pt thin films had a roughness factor of approximately 41, which was a value measured within a range of 10%. This indicates that the thin film according to the present invention is reproducible.

### EXAMPLE 2

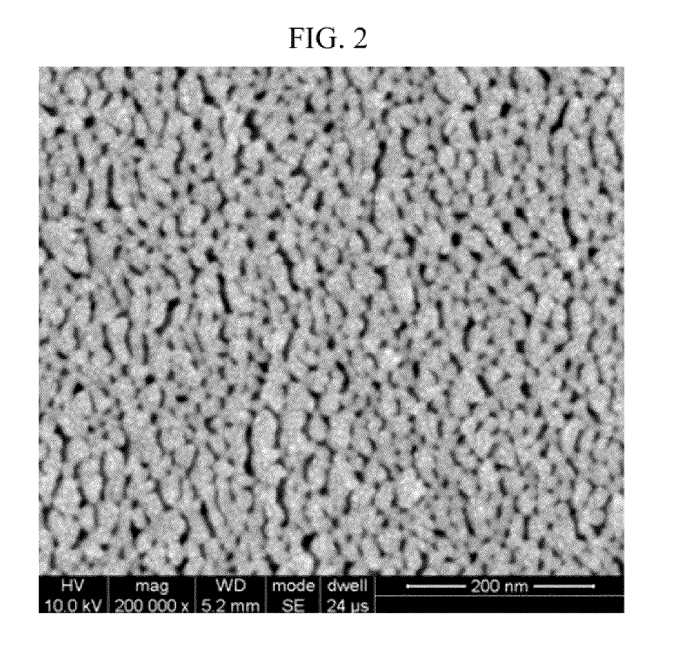

A Pt—Si cosputter thin film having a thickness of 100 nm was fabricated in the same manner as in Example 1. Thereafter, the Pt—Si cosputter thin film was dry-etched using a plasma-type RIE method. SF₆ gas was converted into plasma at 50 mTorr and an RF power of 200 W, and Si was then removed by dry-etching for 1 minute. Also, O₂ gas was converted into plasma under the same conditions, and the plasma cleaning was performed together. FIG. 2 is a top view of the Pt porous thin film obtained via this method. It can be seen that the thin film had a porous structure having a size of approximately 10 nm.

### EXAMPLE 3

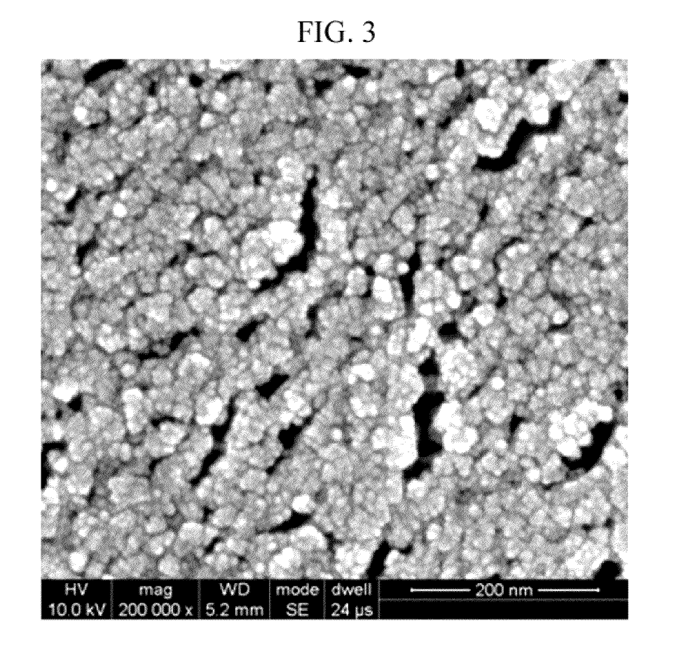

An Au—Si cosputter thin film having a thickness of 200 nm was fabricated in the same manner as in Example 1. Thereafter, the Au—Si cosputter thin film was dry-etched for 1 minute in the same manner as in Example 1 using non-plasma-type XeF₂ dry etcher to remove elemental Si. FIG. 3 is a top view of the Au porous thin film obtained via this method. It can be seen that the thin film showed similar porosity as in Example 1, but had a porous structure having a size of 10 nm to several tens of nanometers.

### EXAMPLE 4

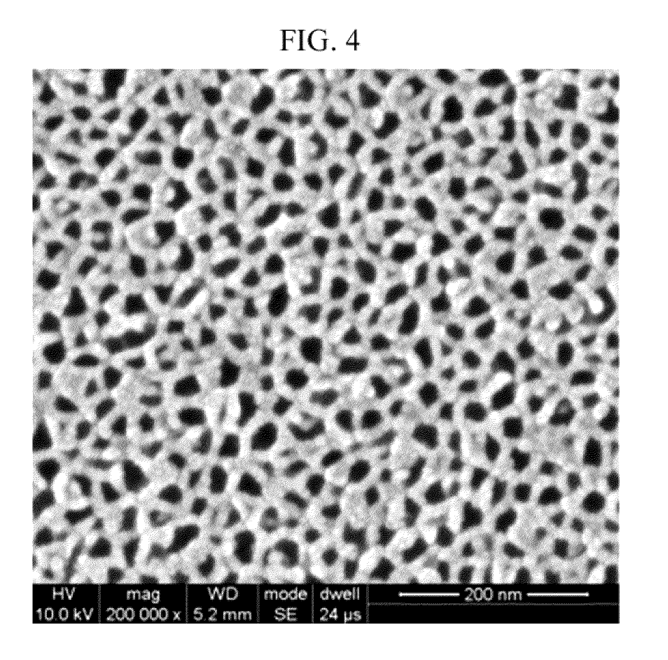

A Pt—Cr cosputter thin film having a thickness of 200 nm was fabricated in the same manner as in Example 1. Thereafter, the Pt—Cr cosputter thin film was dry-etched using a plasma-type ICP etching method. Cl₂ gas was converted into plasma at 50 mTorr, an RF power of 800 W and an RF bias power of 12 W, and Cr was then removed by dry-etching for 1 minute. Also, O₂ gas was converted into plasma under the same conditions and plasma cleaning was performed. FIG. 4 is a top view of the Pt porous thin film obtained via this method. Since Cr was removed by etching the thin film anisotropically as high-energy ions collided with the thin film, the bombardment energy of the ions affected the remaining Pt structure. As a result, it can be seen that a shape of the thin film was different from that of Example 1, but the thin film also had a porous structure having a size of several tens of nanometers.

### EXAMPLE 5

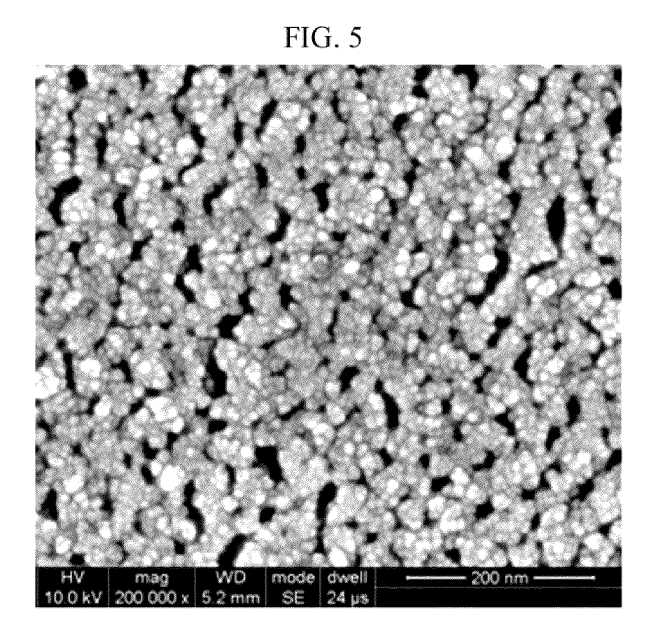

An Ag—Si cosputter thin film having a thickness of 200 nm was fabricated in the same manner as in Example 1. Thereafter, the Ag—Si cosputter thin film was dry-etched for 1 minute in the same manner as in Example 1 using a non-plasma-type XeF₂ dry etcher to remove elemental Si. FIG. 5 is a top view of the Ag porous thin film obtained via this method. It can be seen that the thin film had a porous structure having a size of 10 nm to several tens of nanometers.

### EXAMPLE 6

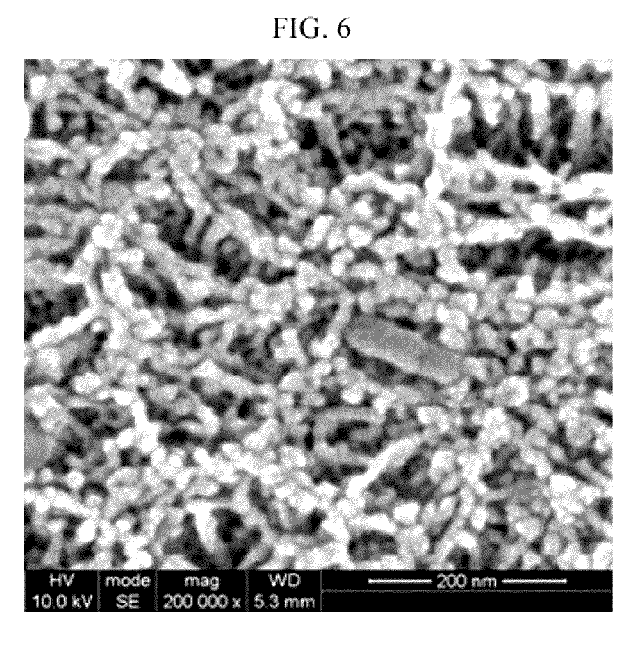

A Pd—Si cosputter thin film having a thickness of 150 nm was fabricated in the same manner as in Example 1. Thereafter, the Pd—Si cosputter thin film was dry-etched for 2 minutes in the same manner as in Example 1 using a non-plasma-type XeF₂ dry etcher to remove elemental Si. FIG. 6 is a top view of the Pd porous thin film obtained via this method. It can be seen that the porosity of the thin film increased with etching time, and the thin film had a porous structure having a size of several tens of nanometers to 100 nm.

According to the present invention, since the entire process of fabricating a porous thin film structure is performed using only a dry process, process control can be simply accomplished, environmental impact is low, and mass production is possible, in contrast to when using a typical wet process such as electrodeposition or dealloying.

According to the present invention, since all processes spanning from forming a thin film structure to fabricating a porous thin film structure may be performed using a batch process there are advantages in processing. Also, since the batch process can be used to manufacture several mesoporous thin film structures while maintaining uniform porosity, it is possible to mass-produce the thin film structure.

Also, since the porous thin film structure fabricated according to the present invention has uniform porosity, a number of sensors can have a reproducible level of sensitivity when the sensors are fabricated using the porous thin film structure according to the present invention.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A method of fabricating a porous thin film structure, comprising:
forming an alloy thin film by depositing at least two elements having different reactivity with a certain reactive gas at the same time; and
fabricating a porous thin film by selectively removing the element having the higher reactivity with the certain reactive gas from the alloy thin film.

2. The method of claim 1, wherein, in the forming of the alloy thin film, the alloy thin film is formed by one of methods such as sputter-deposition, PVD (physical vapor deposition), CVD (chemical vapor deposition), CVD based deposition, and plasma deposition of the at least two elements.

3. The method of claim 1, wherein the alloy thin film includes at least two elements selected from the group consisting of Pt, Pd, Ru, Rh, Ag, Au, Cr, Mn, Fe, Co, Ni, Cu, Si, As, Ge, Os, Re, Te, Ir, Al, B, C, O, N, P, Ti, V, Zr, Nb, Mo, Hf, Ta and W.

4. The method of claim 1, wherein, in the fabricating of the porous thin film, the element to be selectively removed is at least one selected from the group consisting of Si, As, Ge, Os, Re, Te, Ir, Al, B, C, O, N, P, Cu, Cr, Ti, V, Zr, Nb, Mo, Hf, Ta and W.

5. The method of claim 1, wherein, in the fabricating of the porous thin film, the element is selectively removed using one of methods such as reactive ion etching (RIE), inductively coupled plasma (ICP), electron cyclotron resonance (ECR) and helicon discharge.

6. The method of claim 1, wherein, in the fabricating of the porous thin film, the element is selectively removed using at least one reactive gas selected from the group consisting of non-plasma-type reactive gases containing fluorine (F), a group of non-plasma-type reactive gases containing chlorine (Cl), and a group of non-plasma-type reactive gases containing bromine (Br).

7. A porous thin film structure fabricated by the method defined in any one of claims 1 to 6, which includes pores having a size of 0.1 to 500 nm.

8. The porous thin film structure of claim 7, wherein the porous thin film structure has a thin film thickness of 0.1 to 1,000 nm and a roughness factor of 1 to 1,000.
